(19) United States
(12) Patent Application Publication
(10) Pub. No.: US 2007/0114936 A1
(43) Pub. Date: May 24, 2007

(54) Plasma display apparatus and method of manufacturing the same

(76) Inventors: Hyoung-Bin Park, Suwon-si (KR); Seung-Hyun Son, Suwon-si (KR); Sang-Hun Jang, Suwon-si (KR); Gi-Young Kim, Suwon-si (KR); Sung-Soo Kim, Suwon-si (KR); Ho-Nyeon Lee, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/600,507

(22) Filed: Nov. 16, 2006

(30) Foreign Application Priority Data
Nov. 23, 2005 (KR) 10-2005-0112239

(51) Int. Cl. H01J 17/49

(52) U.S. Cl. 313/587; 313/583

(57) ABSTRACT

A plasma display apparatus having an improved structure so as to increase luminescence efficiency and uniformity and a method of manufacturing the display apparatus are provided. The display apparatus includes: a front substrate and a rear substrate facing each other; a plurality of first and second sustain electrodes formed on the front substrate and spaced apart from each other; and first and second electron emitting layers formed on the first and second sustain electrodes, respectively, emitting electrons received from the first and second sustain electrodes, and having a structure in which their thickness decreases as they approach a gap between the first and second sustain electrodes.

### CROSS-REFERENCE TO RELATED PATENT APPLICATION

This application claims the benefit of Korean Patent Application No. 10-2005-0112239, filed on Nov. 23, 2005 in the Korean Intellectual Property Office, the disclosure of which is incorporated herein in its entirety by reference.

### BACKGROUND OF THE INVENTION

1. Field of the Invention

The present embodiments relate to a plasma display apparatus, and more particularly, to a plasma display apparatus having an improved structure so as to increase luminescence efficiency and uniformity and a method of manufacturing the plasma display apparatus.

2. Description of the Related Art

Plasma display panels (PDPs) form images using electrical discharge, have good brightness characteristics and a wide viewing angle, etc., leading to an increase in the use of PDPs recently. PDPs display images using visible light emitted through a process of exciting a phosphor material with ultraviolet rays generated from a discharge of a discharge gas between electrodes when a direct current (DC) voltage or an alternating current (AC) voltage is applied to the electrodes. PDPs are classified into DC type panels and AC type panels according to the discharge process (the discharge method). Also, PDPs are classified into facing discharge type panels and surface discharge type panels according to the arrangement of electrodes.

FIG. 1 is an exploded perspective view of a conventional plasma display panel (PDP).

Referring to FIG. 1, the conventional PDP includes a rear substrate 10 and a front substrate 20, which face each other, and a plurality of barrier ribs 13 interposed between the rear substrate 10 and the front substrate 20 form discharge spaces 15 which are filled with a discharge gas such as Xenon Xe. The barrier ribs 13 partition a plurality of unit discharge cells and prevent electrical and optical crosstalk between the unit discharge cells. The rear substrate 10 includes address electrodes 11 that are covered by a first dielectric layer 12 that is coated with phosphor layers 14 including red R, green G, and blue B phosphor layers. The front substrate 20 includes first and second sustain electrodes 21a and 21b on which first and second bus electrodes 22a and 22b are formed, respectively, to reduce line resistance of the first and second sustain electrodes 21a and 21b. A second dielectric layer 23 covers the first and second sustain electrodes 21a and 21b and the first and second bus electrodes 22a and 22b. A protective layer 24 formed of MgO is formed on the second dielectric layer 23. The protective layer 24 prevents the second dielectric layer 23 from being damaged due to plasma sputtering, emits secondary electrons during a plasma discharge, and reduces a discharge voltage.

The conventional PDP illustrated in FIG. 1 continuously supplies and accelerates electrons through a discharge, generates excitation particles due to collisions of the accelerated electrons and neutral particles, emits ultraviolet rays owing to the stabilization of the excitation particles, excites a phosphor substance by incidence of the ultraviolet rays to form visible light, emits the visible light through the front substrate 20, and displays images.

However, the density of electron emission contributing to the discharge is not constant in the unit discharge cells, thus reducing luminescence uniformity of the conventional PDP illustrated in FIG. 1. In detail, the current density is high inside the first and second sustain electrodes 21a and 21b, resulting in a strong luminescence, and the current density is low outside the first and second sustain electrodes 21a and 21b, resulting in a weak luminescence. That is, an electric field of the unit discharge cells is not constant so that areas having strong luminescence and weak luminescence coexist. As a result, the conventional PDP has a high discharge voltage and a low discharge or luminescence efficiency. Therefore, it is necessary to improve the structure of the PDP so as to increase the luminescence efficiency and uniformity.

### SUMMARY OF THE INVENTION

The present embodiments provide a plasma display apparatus having an improved structure so as to increase luminescence efficiency and uniformity and a method of manufacturing the plasma display apparatus.

According to an aspect of the present embodiments, there is provided a plasma display apparatus, comprising: a front substrate and a rear substrate facing each other; a plurality of first and second sustain electrodes formed on the front substrate and spaced apart from each other; and first and second electron emitting layers formed on the first and second sustain electrodes, respectively, emitting electrons received from the first and second sustain electrodes, and having a structure in which their thickness decreases as the first and second electron emitting layers approach a gap between the first and second sustain electrodes.

The first and second electron emitting layers may be formed of an oxidized porous polysilicon (OPPS) or an oxidized porous amorphous silicon (OPAS). The first and second sustain electrodes may be formed of one selected from a group consisting of indium tin oxide (ITO), Al, and Ag. The density of electrons emitted from the first and second electron emitting layers may be relatively varied according to the width of the first and second electron emitting layers. The closer the first and second electron emitting layers are to the gap between the first and second sustain electrodes, the lower the density of electrons emitted from the first and second electron emitting layers is. The further the first and second electron emitting layers are from the gap between the first and second sustain electrodes, the higher the density of electrons emitted from the first and second electron emitting layers is. The first emitter electrode may be interposed between the first sustain electrode and the first electron emitting layer, and the second emitter electrode may be interposed between the second sustain electrode and the second electron emitting layer, wherein the first and second emitter electrodes may be formed of a conductive material.

According to another aspect of the present embodiments, there is provided a plasma display apparatus, comprising: a front substrate and a rear substrate facing each other; a plurality of first and second sustain electrodes formed on the front substrate and spaced apart from each other; first and second electron emitting layers formed on the first and second sustain electrodes, respectively, emitting electrons received from the first and second sustain electrodes; and a dielectric layer covering the first and second electron emitting layers, having a window exposing an upper face of the first and second electron emitting layers, and having a structure in which the closer the first and second electron emitting layers are to a gap between the first and second sustain electrodes, the thinner the window becomes.

The first and second electron emitting layers may be formed of an OPPS or an OPAS. The first and second sustain electrode are formed of one selected from a group consisting of ITO, Al, and Ag. A density of electrons emitted from the first and second electron emitting layers may be relatively varied according to the width of the window. The closer the first and second electron emitting layers are to the gap between the first and second sustain electrodes, the lower the density of electrons emitted from the first and second electron emitting layers is. The farther the first and second electron emitting layers are from the gap between the first and second sustain electrodes, the higher the density of electrons emitted from the first and second electron emitting layers is.

According to another aspect of the present embodiments, there is provided a method of manufacturing a plasma display apparatus, the method comprising: preparing a front substrate and a rear substrate facing each other; forming a plurality of first and second sustain electrodes on the front substrate to be spaced apart from each other; forming first and second silicon layers on the first and second sustain electrodes, respectively; anodizing the first and second silicon layers and forming first and second electron emitting layers formed of an oxidized porous silicon; and selectively etching and removing a specific area of the first and second electron emitting layers so that the thinner the first and second electron emitting layers are, the closer the first and second electron emitting layers approach a gap between the first and second sustain electrodes.

A solution of hydrogen fluoride (HF) and ethanol may be used for the anodizing process. The first and second sustain electrodes may be formed of one selected from a group consisting of ITO, Al, and Ag. A gap between the first and second electron emitting layers may be adjusted to control a discharge start voltage.

According to another aspect of the present embodiments, there is provided a method of manufacturing a plasma display apparatus, the method comprising: preparing a front substrate and a rear substrate facing each other; forming a plurality of first and second sustain electrodes on the front substrate to be spaced apart from each other; forming first and second silicon layers on the first and second sustain electrodes, respectively; anodizing the first and second silicon layers and forming first and second electron emitting layers formed of an oxidized porous silicon, using an anodizing process; forming a dielectric layer covering the first and second electron emitting layers; and selectively etching and removing a specific area of the dielectric layer, having a window exposing an upper face of the first and second electron emitting layers, and having a structure in which the thinner the window is, the closer the first and second electron emitting layers are to a gap between the first and second sustain electrodes.

A solution of HF and ethanol may be used for the anodizing process. The first and second sustain electrodes may be formed of one selected from a group consisting of ITO, Al, and Ag. A gap between the first and second electron emitting layers may be adjusted to control a discharge start voltage.

### BRIEF DESCRIPTION OF THE DRAWINGS

The above and other features and advantages of the present embodiments will become more apparent by describing in detail exemplary embodiments thereof with reference to the attached drawings in which:

FIG. 1 is an exploded perspective view of a conventional plasma display panel (PDP);

FIG. 2A is an exploded perspective view of a plasma display apparatus according to an embodiment;

FIG. 2B is a cross-sectional view of the plasma display apparatus of FIG. 2A taken along a line A-A′ in FIG. 2A;

FIG. 3A is an exploded perspective view of a plasma display apparatus according to another embodiment;

FIG. 3B is a cross-sectional view of the plasma display apparatus of FIG. 3A taken along a line B-B′ in FIG. 3A according to an embodiment;

FIGS. 4A through 4H are diagrams illustrating a method of manufacturing a plasma display apparatus, according to an embodiment; and

FIGS. 5A through 5I are diagrams illustrating a method of manufacturing a plasma display apparatus, according to another embodiment.

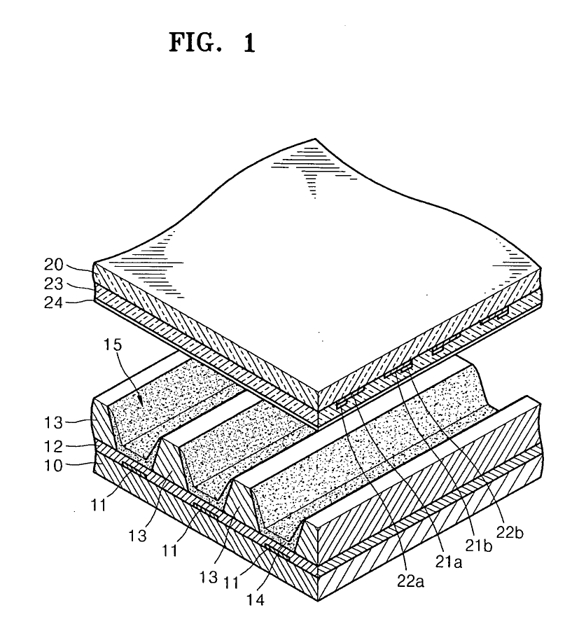

### DETAILED DESCRIPTION OF THE INVENTION

The present embodiments will now be described more fully with reference to the accompanying drawings, in which exemplary embodiments are shown. In the drawings, the thickness of layers and regions are exaggerated for clarity.

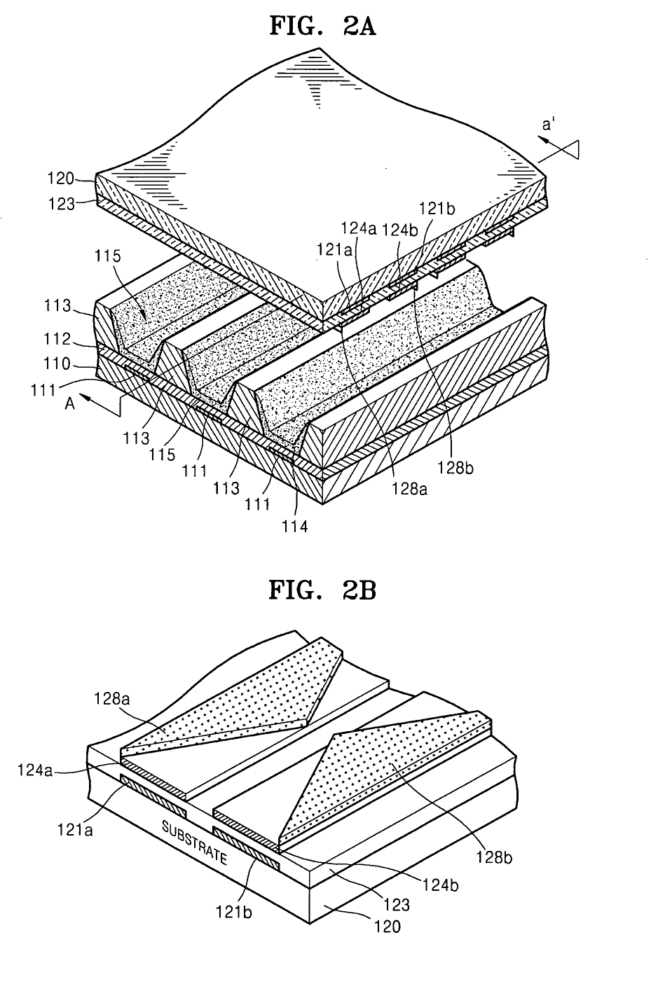

FIG. 2A is an exploded perspective view of a plasma display apparatus according to an embodiment. FIG. 2B is a cross-sectional view of the plasma display apparatus of FIG. 2A taken along a line A-a′ in FIG. 2A according to an embodiment. A plasma display panel (PDP) is realized as an example of the plasma display apparatus according to the current embodiment.

Referring to FIGS. 2A and 2B, the plasma display apparatus according to the current embodiment includes a front substrate 120 and a rear substrate 110 which face each other, and a plurality of barrier ribs 113 interposed between the front substrate 120 and the rear substrate 110, forming discharge spaces 115 filled with a discharge gas such as, for example, Neon Ne or Xenon Xe. The barrier ribs 113 partition a plurality of unit discharge cells. The discharge gas generates a visible light in the unit discharge cells during a plasma discharge. The barrier ribs 113 prevent electrical or optical crosstalk between the unit discharge cells.

The rear substrate 110 includes address electrodes 111 and a first dielectric layer 112 that covers the address electrodes 111. The first dielectric layer 112 is coated with phosphor layers 114 including red R, green G, and blue B phosphor layers. The front substrate 120 includes first and second sustain electrodes 121a and 121b which are spaced apart from each other. A second dielectric layer 123 covers the first and second sustain electrodes 121a and 121b. First and second emitter electrodes 124a and 124b formed of conductive materials such as indium tin oxide (ITO), Al, Ag, etc. are formed on the second dielectric layer 123, and correspond to the first and second sustain electrodes 121a and 121b, respectively. First and second electron emitting layers 128a and 128b formed of an oxidized porous silicon (OPS) material are formed on the first and second emitter electrodes 124a and 124b, respectively. The OPS material is an oxidized porous polysilicon (OPPS) or an oxidized porous amorphous silicon (OPAS).

If a specific alternating current (AC) voltage is applied to the first and second sustain electrodes 121a and 121b, an electric field having a specific magnitude is formed between the first and second sustain electrodes 121a and 121b so that the first and second emitter electrodes 124a and 124b supply electrons to the first and second electron emitting layers 128a and 128b, respectively. The electrons are accelerated through the first and second emitting layers 128a and 128b and emitted to the discharge spaces 115. More specifically, silicon nano-crystallization particles forming the first and second electron emitting layers 128a and 128b have a diameter of about 5 nm. The diameter of the silicon nano-crystallization particles is much smaller than a means free path of about 50 nm of the electrons. Therefore, the electrons are not likely to collide with each other in the silicon nano-crystallization particles, and most of the electrons reach the interface of the silicon nano-crystallization particles through the silicon nano-crystallization particles. A very thin oxidization film is formed between the silicon nano-crystallization particles forming an electric field area in the first and second electron emitting layers 128a and 128b when a specific voltage is applied to the first and second sustain electrodes 121a and 121b. The electrons tunnel through the oxidization film, are accelerated in the electric field area formed in the first and second electron emitting layers 128a and 128b, and are emitted to the discharge spaces 115. Therefore, the first and second electron emitting layers 128a and 128b of the plasma display apparatus according to the current embodiment can improve discharge and brightness characteristics of the plasma display apparatus.

In particular, the closer the first and second electron emitting layers 128a and 128b are to a gap between the first and second emitter electrodes 124a and 124b, the thinner the first and second electron emitting layers 128a and 128b are. The first and second emitter electrodes 124a and 124b may have the same structure as the first and second electron emitting layers 128a and 128b. In this case, the density of the electrons emitted from the first and second electron emitting layers 128a and 128b is changed according to the width of the first and second electron emitting layers 128a and 128b. For example, the closer the first and second electron emitting layers 128a and 128b are to the gap between the first and second emitter electrodes 124a and 124b, the lower the density of the electrons emitted from the first and second electron emitting layers 128a and 128b is, and vice versa. Since the density of the electrons is changed according to the width of the first and second electron emitting layers 128a and 128b, the width of the first and second electron emitting layers 128a and 128b is controlled according to the location thereof so that the electric field can be uniformly distributed in the unit discharge cells.

In comparison with the structure in which the width of the first and second electron emitting layers 128a and 128b is gradually changed and the structure in which the electron emitting layers 128a and 128b has a uniform width in the unit discharge cells, the density of the electrons contributing to the discharge is more uniform than the discharge spaces 115. The plasma display apparatus of the current embodiment can provide an improved distribution of the electric field in the unit discharge cells compared to the conventional PDP. The conventional PDP has a strong luminescence since the current density is high inside the first and second sustain electrodes 21a and 21b, and has a weak luminescence since the current density is low outside the first and second sustain electrodes 21a and 21b. However, the plasma display apparatus of the current embodiment has a weak current density by relatively decreasing the width of the first and second electron emitting layers 128a and 128b inside the first and second sustain electrodes 121a and 121b, and has a strong current density by relatively increasing the width of the first and second electron emitting layers 128a and 128b outside the first and second sustain electrodes 121a and 121b. Therefore, the unit discharge cells have a uniformly distributed electric field, thereby increasing luminescence efficiency and uniformity in the unit discharge cells and improving the voltage and brightness characteristics of the plasma display apparatus.

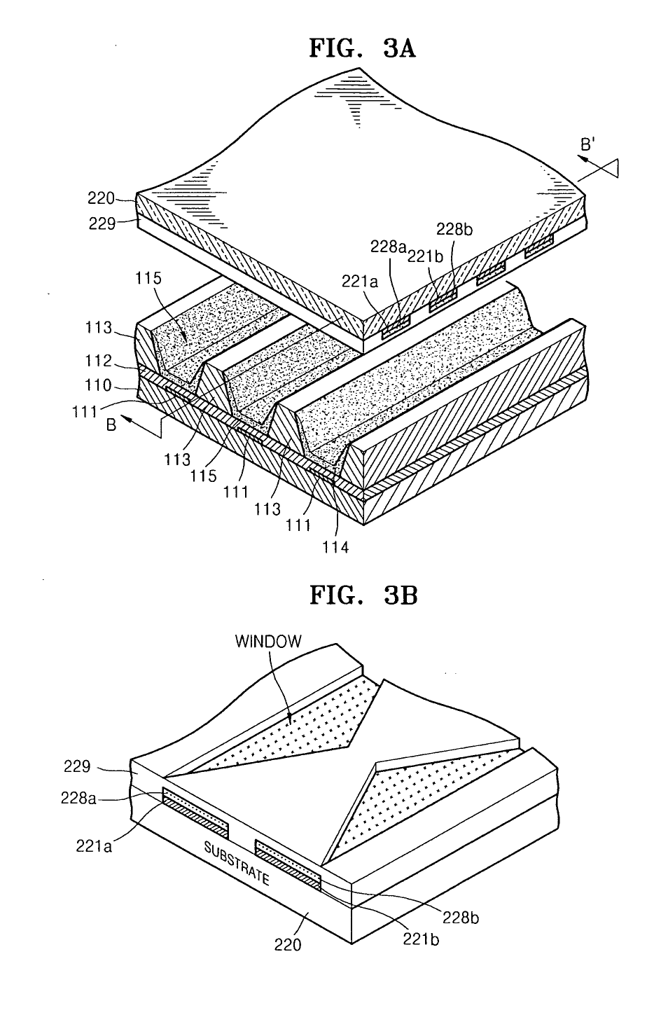

FIG. 3A is an exploded perspective view of a plasma display apparatus according to another embodiment. FIG. 3B is a cross-sectional view of the plasma display apparatus of FIG. 3A taken along a line B-B′ in FIG. 3A according to an embodiment. A PDP is realized as an example of the plasma display apparatus according to the current embodiment.

Like reference numerals in FIGS. 3A and 3B denote like elements illustrated in FIGS. 2A and 2B, and thus descriptions thereof will be omitted. A front substrate 220 of the plasma display apparatus of FIGS. 3A and 3B is different from the front substrate 120 of the plasma display apparatus of FIGS. 2A and 2B.

Referring to FIGS. 3A and 3B, the plasma display apparatus includes the front substrate 220 and a rear substrate 110 which face each other, and a plurality of barrier ribs 113 interposed between the front substrate 220 and the rear substrate 110, forming discharge spaces 115 filled with a discharge gas such as Neon Ne or Xenon Xe. The barrier ribs 113 partition a plurality of unit discharge cells.

The rear substrate 110 includes address electrodes 111 and a first dielectric layer 112 that covers the address electrodes 111. The first dielectric layer 112 is coated with phosphor layers 114 including red R, green G, and blue B phosphor layers. The front substrate 220 includes first and second sustain electrodes 221a and 221b which are spaced apart from each other. First and second electron emitting layers 228a and 228b formed of an OPS material are formed on the first and second sustain electrodes 221a and 221b, respectively. A second dielectric layer 229 covers the first and second electron emitting layers 228a and 228b. The second dielectric layer 229 includes a window that exposes upper faces of the first and second electron emitting layers 228a and 228b to the discharge spaces 115. The closer the first and second electron emitting layers 228a and 228b are to a gap between the first and second sustain electrodes 221a and 221b, the thinner the window becomes. In this case, a density of electrons emitted from the first and second electron emitting layers 228a and 228b is changed according to the thickness of the window. For example, the closer the first and second electron emitting layers 228a and 228b are to the gap between the first and second sustain electrodes 221a and 221b, the lower the density of the electrons emitted from the first and second electron emitting layers 228a and 228b is, and vice versa. As described in FIGS. 2A and 2B, the plasma display apparatus of the current embodiment can increase luminescence efficiency and uniformity in the unit discharge cells and thus improve voltage and brightness characteristics of the plasma display apparatus. The first and second sustain electrodes 221a and 221b can be formed of a material selected from the group consisting of ITO, Al, and Ag.

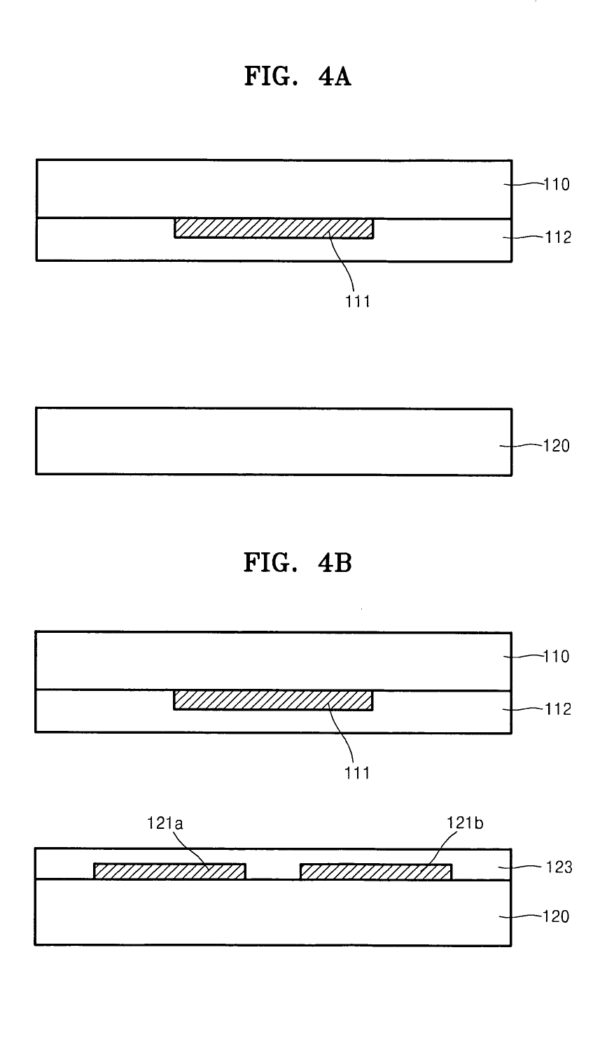

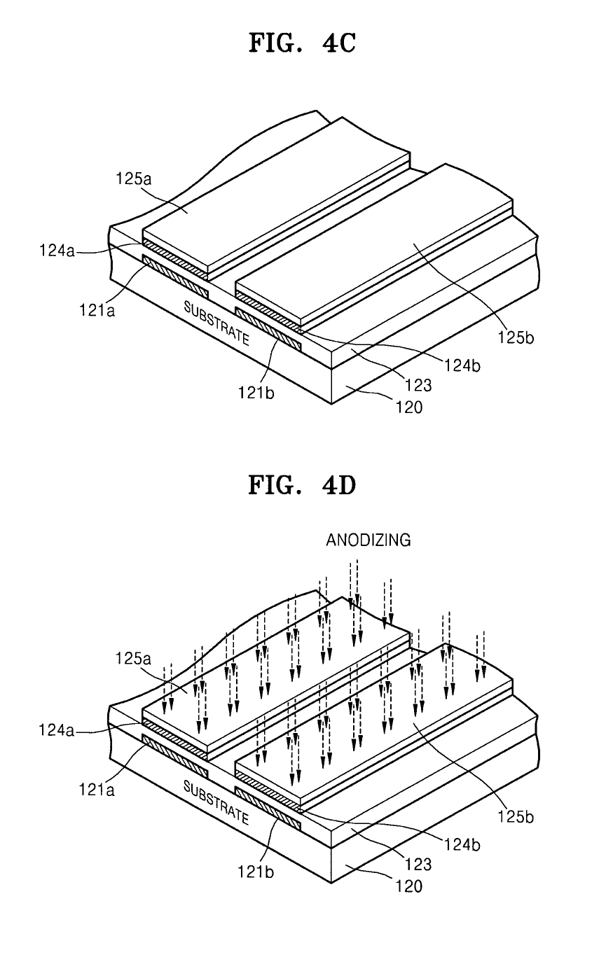

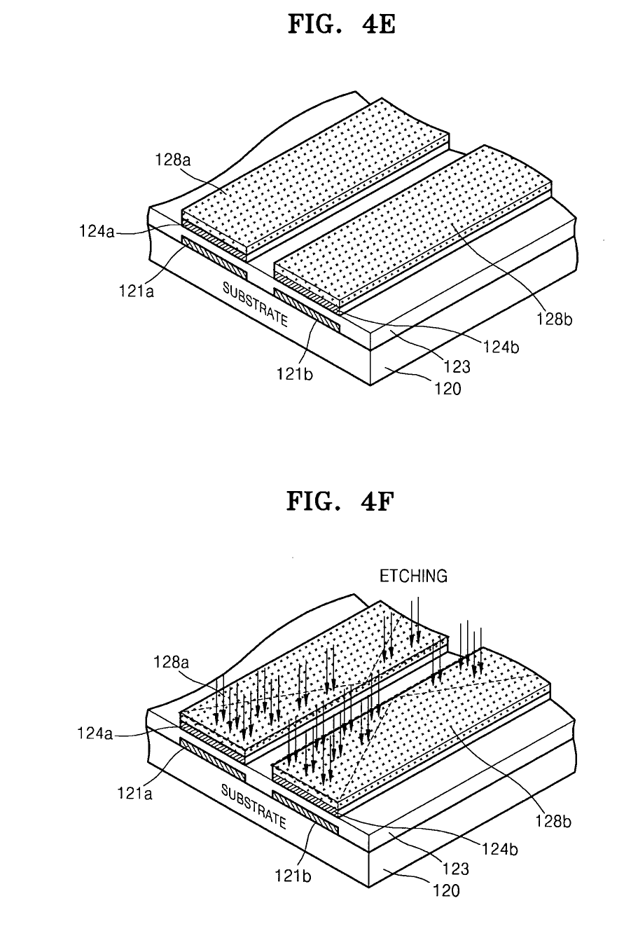

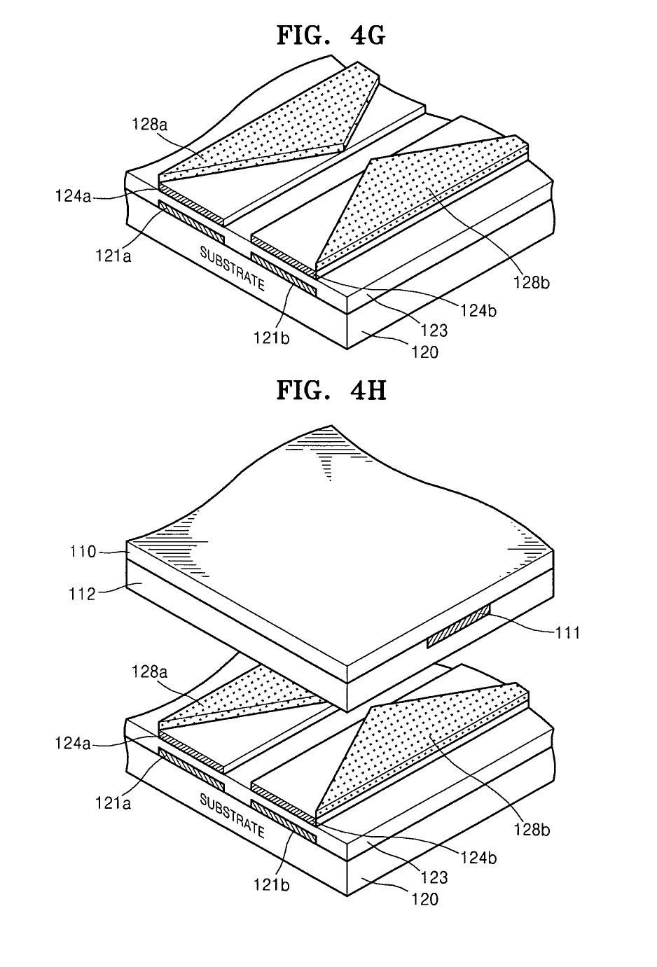

FIGS. 4A through 4H are diagrams illustrating a method of manufacturing a plasma display apparatus according to an embodiment. A PDP is realized as an example of the plasma display apparatus according to the current embodiment. Material layers can be formed using various widely known thin film deposition methods. Such thin film deposition methods include physical vapor deposition (PVD), chemical vapor deposition (CVD), spray coating, screen printing, etc.

Referring to FIGS. 4A and 4B, a front substrate 120 and a rear substrate 110 are prepared facing each other Address electrodes 111 and a first dielectric layer 112 that covers the address electrodes 111 are formed on the rear substrate 110. First and second sustain electrodes 121a and 121b formed on the front substrate 120 to be spaced apart from each other, are formed of a conductive material such as ITO, Al, or Ag. A second dielectric layer 123 covers the first and second sustain electrodes 121a and 121b.

Referring to FIGS. 4C through 4E, first and second emitter electrodes 124a and 124b are formed on the second dielectric layer 123 so as to correspond to the first and second sustain electrodes 121a and 121b, respectively. The first and second emitter electrodes 124a and 124b are formed of a conductive material such as ITO, Al, or Ag. First and second silicon layers 125a and 125b are formed on the first and second emitter electrodes 124a and 124b, respectively. The first and second silicon layers 125a and 125b are formed of a polycrystalline silicon or an amorphous silicon.

The first and second silicon layers 125a and 125b are anodized to form first and second electron emitting layers 128a and 128b, which are formed of an OPS material. Any anodizing process is known in the art can be used. In the current embodiment, a solution of hydrogen fluoride (HF) and ethanol is used for the anodizing process, thereby obtaining an OPS layer.

Referring to FIGS. 4F through 4H, a specific area of the first and second electron emitting layers 128a and 128b is etched and removed in order to decrease the thickness of the first and second electron emitting layers 128a and 128b when the first and second electron emitting layers 128a and 128b are close to a gap between the first and second emitter electrodes 124a and 124b, thereby obtaining a plasma display apparatus having improved luminescence efficiency and uniformity.

A gap between the first and second electron emitting layers 128a and 128b can influence a discharge start voltage of the plasma display apparatus. Therefore, the gap between the first and second electron emitting layers 128a and 128b may be controlled in order to minimize the discharge start voltage. For example, the gap between the first and second electron emitting layers 128a and 128b can be increased or decreased during the etching process.

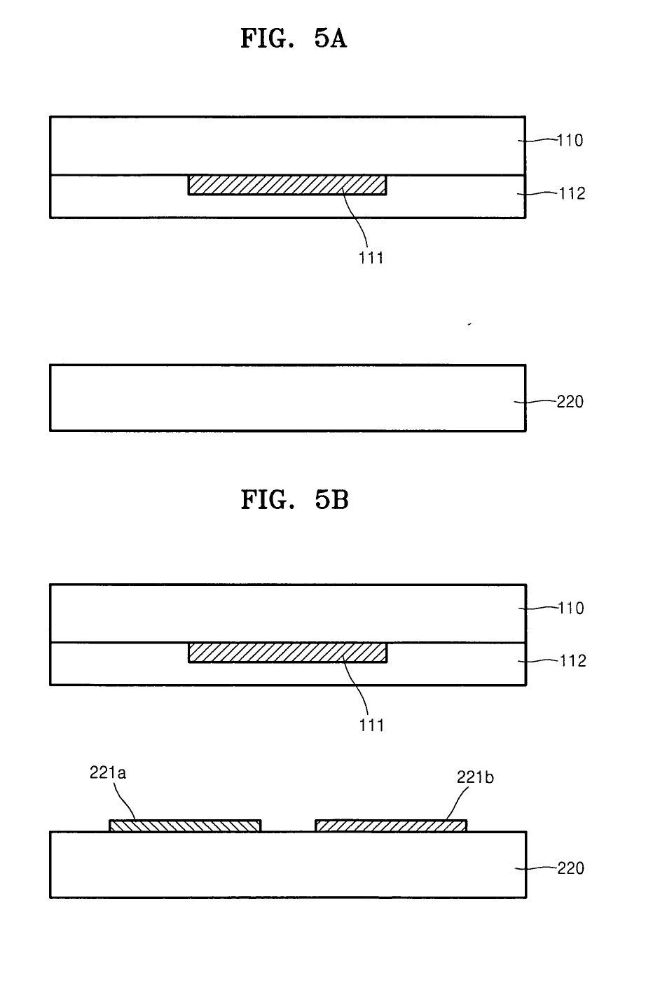

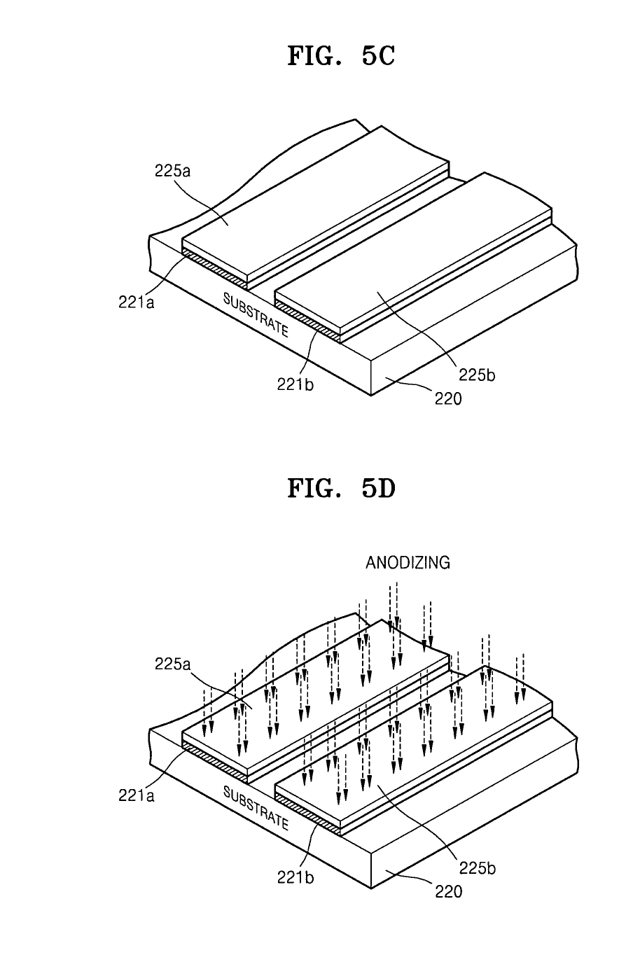

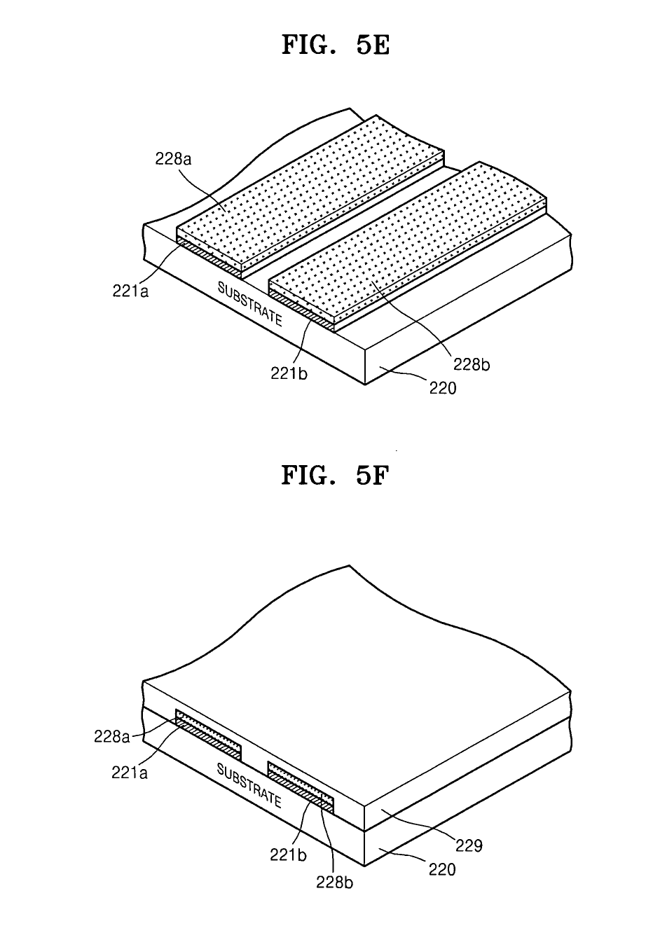

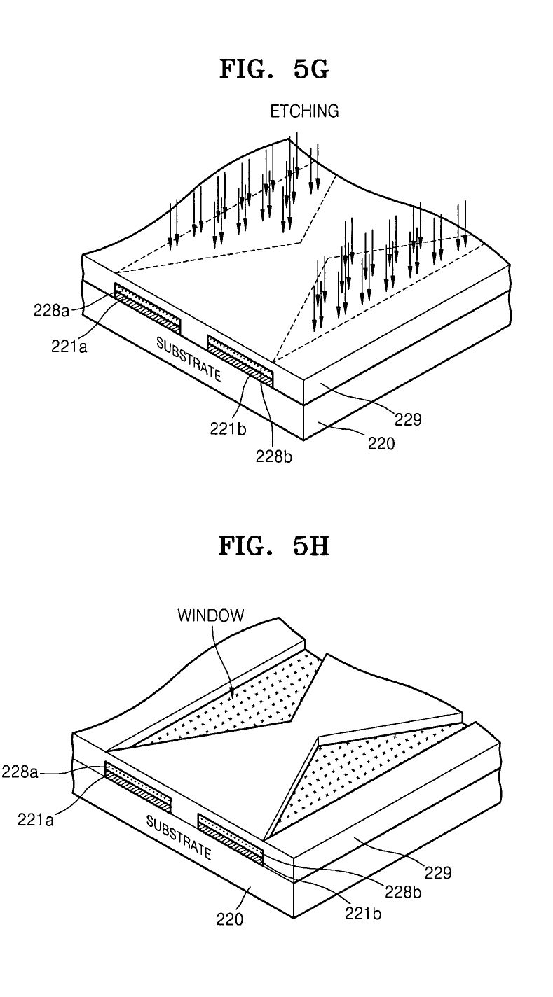

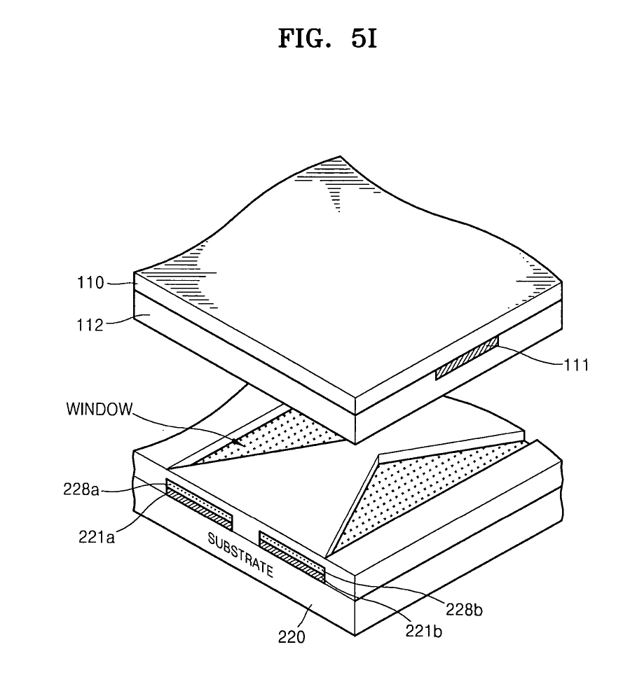

FIGS. 5A through 5I are diagrams illustrating a method of manufacturing a plasma display apparatus according to another embodiment. A PDP is realized as an example of the plasma display apparatus according to the current embodiment.

Referring to FIGS. 5A through 5C, a front substrate 220 and a rear substrate 110 are prepared facing each other. Address electrodes 111 and a first dielectric layer 112 that covers the address electrodes 111 are formed on the rear substrate 110. First and second sustain electrodes 221a and 221b are formed on the front substrate 220 and spaced apart from each other. First and second silicon layers 225a and 225b are formed on the first and second sustain electrodes 221a and 221b, respectively. The first and second silicon layers 225a and 225b are formed of a polycrystalline silicon or an amorphous silicon. The first and second sustain electrodes 221a and 221b are formed of a conductive material such as ITO, Al, or Ag.

Referring to FIGS. 5D and 5E, the first and second silicon layers 225a and 225b are anodized to form first and second electron emitting layers 228a and 228b, which are formed of an OPS material. The anodizing process is the same as that described with reference to FIGS. 4A through 4H, and thus a description thereof will be omitted.

Referring to FIGS. 5F through 5I, a second dielectric layer 229 covers the first and second electron emitting layers 228a and 228b. A specific area of the second dielectric layer 229 is etched and removed to form a window that exposes an upper face of the first and second electron emitting layers 228a and 228b to the discharge spaces 115. The closer the first and second electron emitting layers 228a and 228b are to a gap between the first and second sustain electrodes 221a and 221b, the thinner the window becomes, thereby obtaining the PDP having improved luminescence efficiency and uniformity.

As described with reference to FIGS. 4A through 4I, the gap between the first and second electron emitting layers 228a and 228b can influence a discharge start voltage of the plasma display apparatus. Therefore, the gap between the first and second electron emitting layers 228a and 228b may be controlled in order to minimize the discharge start voltage. For example, the gap between the first and second electron emitting layers 228a and 228b can be increased or decreased during the etching process of the second dielectric layer 229.

According to an embodiment, a plasma display apparatus, e.g., a PDP, having improved luminescence efficiency and uniformity in discharge cells can be obtained. In detail, the thickness of electron emitting layers is changed according to their position relative to unit discharge cells so that the density of emitted electrons contributed to a discharge can be uniformly distributed, thereby optimizing discharge efficiency. The unit discharge cells can be controlled to have a uniform distribution of electric field so that the plasma display apparatus has high discharge efficiency at a low voltage, thereby improving brightness and voltage characteristics of the plasma display apparatus.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display apparatus, comprising:
a front substrate and a rear substrate facing each other;
a plurality of first and second sustain electrodes formed on the front substrate and spaced apart from each other by a gap; and
first and second electron emitting layers formed on the first and second sustain electrodes, respectively, configured to emit electrons received from the first and second sustain electrodes, and having a structure in which their thickness decreases as the first and second electron emitting layers approach the gap between the first and second sustain electrodes.

2. The plasma display apparatus of claim 1, wherein the first and second electron emitting layers are formed of an oxidized porous polysilicon (OPPS) or an oxidized porous amorphous silicon (OPAS).

3. The plasma display apparatus of claim 1, wherein the first emitter electrode is interposed between the first sustain electrode and the first electron emitting layer, and the second emitter electrode is interposed between the second sustain electrode and the second electron emitting layer, wherein the first and second emitter electrodes are formed of a conductive material.

4. The plasma display apparatus of claim 1, wherein the first and second sustain electrodes are formed of one selected from a group consisting of indium tin oxide (ITO), Al, and Ag.

5. The plasma display apparatus of claim 1, wherein the density of electrons emitted from the first and second electron emitting layers is varies according to the width of the first and second electron emitting layers.

6. The plasma display apparatus of claim 5, wherein the closer the first and second electron emitting layers are to the gap between the first and second sustain electrodes, the lower the density of electrons emitted from the first and second electron emitting layers is.

7. The plasma display apparatus of claim 5, wherein the further the first and second electron emitting layers are from the gap between the first and second sustain electrodes, the higher the density of electrons emitted from the first and second electron emitting layers is.

8. A plasma display apparatus, comprising:
a front substrate and a rear substrate facing each other;
a plurality of first and second sustain electrodes formed on the front substrate and spaced apart from each other by a gap;
first and second electron emitting layers formed on the first and second sustain electrodes, respectively, configured to emit electrons received from the first and second sustain electrodes; and
a dielectric layer covering the first and second electron emitting layers, having a window exposing an upper face of the first and second electron emitting layers, and having a structure in which the closer the first and second electron emitting layers are to a gap between the first and second sustain electrodes, the thinner the window becomes.

9. The plasma display apparatus of claim 8, wherein the first and second electron emitting layers are formed of an OPPS or an OPAS.

10. The plasma display apparatus of claim 8, wherein the first and second sustain electrode are formed of one selected from a group consisting of ITO, Al, and Ag.

11. The plasma display apparatus of claim 8, wherein a density of electrons emitted from the first and second electron emitting layers varies according to the width of the window.

12. The plasma display apparatus of claim 11, wherein the closer the first and second electron emitting layers are to the gap between the first and second sustain electrodes, the lower the density of electrons emitted from the first and second electron emitting layers is.

13. The plasma display apparatus of claim 11, wherein the farther the first and second electron emitting layers are from the gap between the first and second sustain electrodes, the higher the density of electrons emitted from the first and second electron emitting layers is.

14. A method of manufacturing a plasma display apparatus, the method comprising:
preparing a front substrate and a rear substrate facing each other;
forming a plurality of first and second sustain electrodes on the front substrate to be spaced apart from each other;
forming first and second silicon layers on the first and second sustain electrodes, respectively;
anodizing the first and second silicon layers and forming first and second electron emitting layers formed of an oxidized porous silicon; and
selectively etching and removing a specific area of the first and second electron emitting layers so that the thinner the first and second electron emitting layers are to each other, the closer the first and second electron emitting layers approach a gap between the first and second sustain electrodes.

15. The method of claim 14, wherein a solution of hydrogen fluoride (HF) and ethanol is used for the anodizing process.

16. The method of claim 14, wherein the first and second sustain electrodes are formed of one selected from a group consisting of ITO, Al, and Ag.

17. The method of claim 14, wherein a gap between the first and second electron emitting layers is adjusted to control a discharge start voltage.

18. A method of manufacturing a plasma display apparatus, the method comprising:
preparing a front substrate and a rear substrate facing each other;
forming a plurality of first and second sustain electrodes on the front substrate configured to be spaced apart from each other;
forming first and second silicon layers on the first and second sustain electrodes, respectively;
anodizing the first and second silicon layers and forming first and second electron emitting layers formed of an oxidized porous silicon, using an anodizing process;
forming a dielectric layer covering the first and second electron emitting layers; and
selectively etching and removing a specific area of the dielectric layer, having a window exposing an upper face of the first and second electron emitting layers, and having a structure in which the thinner the window is, the closer the first and second electron emitting layers are to a gap between the first and second sustain electrodes.

19. The method of claim 18, wherein a solution of HF and ethanol is used for the anodizing process.

20. The method of claim 18, wherein the first and second sustain electrodes are formed of one selected from a group consisting of ITO, Al, and Ag.

21. The method of claim 18, wherein a gap between the first and second electron emitting layers is adjusted to control a discharge start voltage.
